(19) United States
(12) Patent Application Publication
(10) Pub. No.: US 2019/0079190 A1
(43) Pub. Date: Mar. 14, 2019

(54) SYSTEMS AND APPARATUS FOR MONITORING REFUSE IN A SET OF RECEPTICALS

(71) Applicants: Saiman Shetty, Fremont, CA (US); Parshad Divyakant Patel, Mountain View, CA (US)

(72) Inventors: Saiman Shetty, Fremont, CA (US); Parshad Divyakant Patel, Mountain View, CA (US)

(21) Appl. No.: 15/701,452

(22) Filed: Sep. 12, 2017

(51) Int. Cl. G01S 17/10; G01S 17/02; G01S 7/481

(52) U.S. Cl. CPC G01S 17/10; G01S 7/4813; G01S 17/023

(57) ABSTRACT

An apparatus for measuring the distance between a first sensor and a surface in a refuse container is disclosed. The apparatus includes a first transmitter, the first transmitter configured to transmit a first electromagnetic signal toward a set of surfaces at a first time; and, a first receiver coupled to the first transmitter, the first receiver configured to receive a first reflected electromagnetic signal from the set of surfaces at a second time. The apparatus further includes a distance calculating circuit coupled to the first receiver, the distance calculating circuit configured to calculate a first flight time period between the first time and the second time. The apparatus also includes a time-distance conversion circuit coupled to the distance calculating circuit, the time-distance conversion circuit configured to convert the first flight time period to a first distance; wherein a notification is generated if the first distance is less than a first threshold distance.

### CROSS-REFERENCE TO RELATED APPLICATIONS

NONE

### FIELD OF DISCLOSURE

This disclosure relates in general to refuse management and in particular to systems and apparatus for monitoring refuse in a set of receptacles.

### BACKGROUND

In general, a refuse container, usually made out of metal or plastic, is a container for temporarily storing waste. Examples of waste may include general garbage, industrial waste, recycled materials, and yard waste, which are often placed in containers for later removal.

Referring now to FIG. 1, a typical refuse container is shown. In general, a refuse container 102 is comprised of base 104, with lid 106, for holding refuse 108. Lid 106 may further be attached to base 104 with a hinge mechanism, such that refuse 108 may be removed, without also removing lid 106.

However, since removal of refuse is often based on a pre-determined schedule, and not on whether there is sufficient material in a particular container to warrant removal, collection resources tend to be sub-optimally utilized—often incurring substantial additional costs.

In view of the foregoing, there is desire for a system and apparatus for monitoring refuse in a set of receptacles.

### SUMMARY

The invention relates, in one embodiment, to an apparatus for measuring the distance between a first sensor and a surface in a refuse container. The apparatus includes a first transmitter, the first transmitter configured to transmit a first transmitted electromagnetic signal toward a set of surfaces at a first time; and, a first receiver coupled to the first transmitter, the first receiver configured to receive a first reflected electromagnetic signal from the set of surfaces at a second time. The apparatus further includes a distance calculating circuit coupled to the first receiver, the distance calculating circuit configured to calculate a first flight time period between the first time and the second time. The apparatus also includes a time-distance conversion circuit coupled to the distance calculating circuit, the time-distance conversion circuit configured to convert the first flight time period to a first distance; wherein a notification is generated if the first distance is less than a first threshold distance.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a typical container comprising of a base and a lid for holding refuse 108;

FIG. 2 shows a simplified diagram of a refuse container is shown, in accordance with the invention;

FIG. 3 shows a simplified diagram of one embodiment of the invention, in accordance with the invention;

FIG. 4 shows a simplified diagram of another embodiment of the invention, in accordance with the invention;

FIG. 5 shows a simplified logical diagram of principal electronic components of a refuse monitoring apparatus, in accordance with the invention.

FIGS. 6A-D show a simplified logical diagram of principal electronic components of a refuse monitoring apparatus, in accordance with the invention;

FIG. 7A-C shows housing unit and a mounting apparatus, in accordance with the invention;

FIGS. 8A-B show a simplified process of the invention, in which a signal is transmitted to and reflected from a set of refuse, in accordance with the invention; and,

FIG. 9 shows a simplified diagram comparing fullness sensing accuracy vs. distance to a refuse target, for a refuse monitoring apparatus, in accordance of the invention.

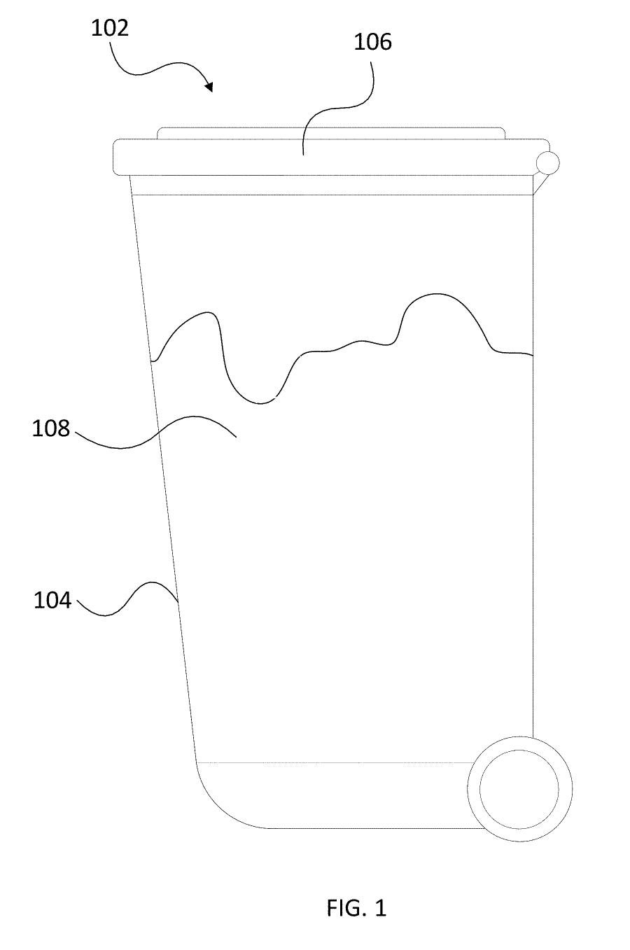

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In general, removal of refuse from a container, particularly in commercial and industrial venues, is often based on a specific schedule, and not on whether there is sufficient material in a particular container to warrant removal. This tends to cause the suboptimal use of resources. For example, the scheduled time to remove the refuse from a container may be after the point at which that container is full. Consequently, that container may start to overflow, or refuse may be placed next to the contain which tends to create clutter in the best case, and a potentially dangerous hazard in the worst. For example, the clutter may present a physical safety hazard to nearby persons or vehicles. In addition, portions overflow may combine with any effluent and enter the sewer system, creating potential safety issues during later processing.

In a non-obvious way, the inventors believe that the present invention addresses these unresolved issues through systems and apparatus for monitoring refuse in a set of receptacles. In general, a refuse container is a container for temporarily storing waste, and is usually comprised of metal, plastic, or a combination thereof.

In addition, the invention may be used in janitorial applications, such as removal of office and industrial waste, as well as health care applications, such as monitoring bio-hazardous materials as would be found in hospitals. Alternative uses may include document destruction applications, such as confidential information bins as provided by document shredding companies.

In one embodiment, the invention may use a LORA method of communication. In another embodiment, the sensing may be ultrasonic, optical, vision, or a fusion of some or all of these.

In another embodiment, the power source [not shown] is one of a battery (e.g., lithium), piezo electric energy harvesting methods, and solar cells combined with circuits that charge a rechargeable battery.

In another embodiment, the refuse monitoring apparatus contains a unicolor or multi-colored LED to indicate device status. In another embodiment, the device includes at least one of a temperature, pressure, odor, CO₂, CO, CH₄, and light sensing sensor.

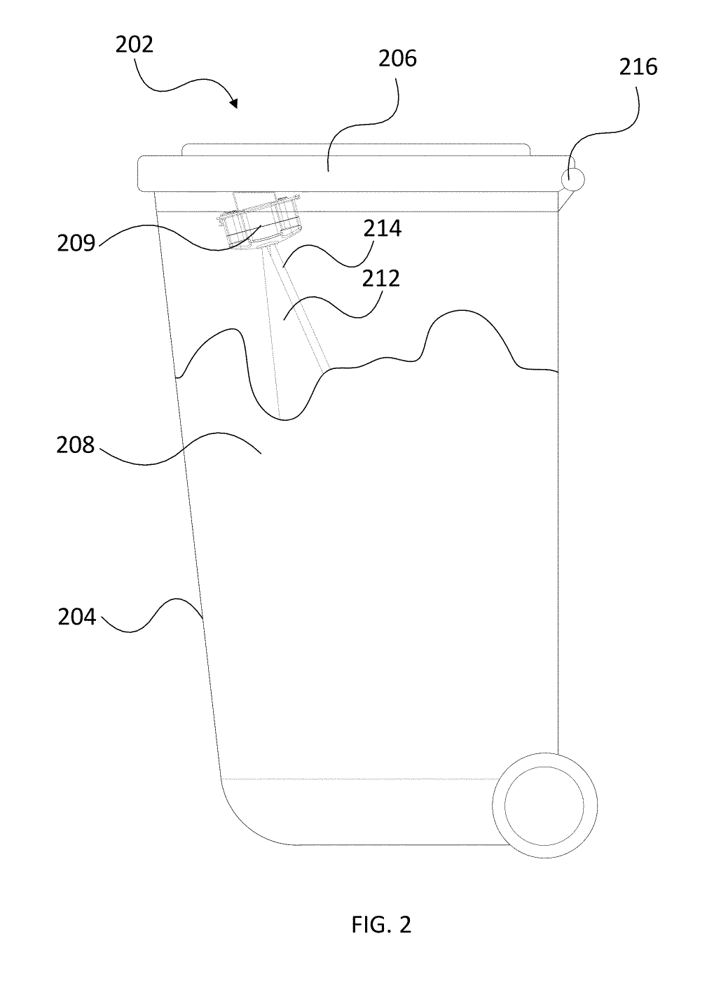

Referring now to FIG. 2, a simplified diagram of a refuse container is shown, in accordance with the invention. In a non-obvious manner, a refuse monitoring device 209 may be positioned to monitor the level of refuse 208, such that if the level of refuse 208 is less than a predetermined distance below the refuse monitoring device, a message is sent to a monitoring application. In one embodiment, a monitoring application is configured to receive and transmit messages to and from a set of refuse monitoring devices (not shown).

In general, a refuse container 202 is comprised of a base 204, with a lid 206, for holding refuse 208. Lid 206 may further be attached to base 204 with a hinge mechanism 216, such that refuse 208 may be removed, without also removing lid 206.

In a non-obvious manner, refuse monitoring apparatus 209 may be attached beneath lid 206, such that refuse monitoring apparatus 209 may substantially monitor refuse 208, when lid 206 substantially closed.

In one embodiment, refuse monitoring apparatus 209 is configured to transmit an electromagnetic wave 212 at a first time and at a frequency for which refuse 208 appears substantially opaque. In general, electromagnetic wave 212 is transmitted in cone shape, the diameter of which expands as the distance increases away from refuse monitoring apparatus 210.

A portion of electromagnetic wave 212 may then be reflected back from refuse 208 within sensor field of view 214, and received by monitoring apparatus 209 at a second time. In general, a distance calculating circuit within monitoring apparatus 209, is configured to measure the period of time (flight time) between the transmission (at a first time) and the reception (at a second time) of electromagnetic wave 212, and then calculate a distance (refuse distance) from refuse monitoring apparatus 209 to a surface of refuse 208. An approximate level of refuse 208 within refuse container 102 may then be calculated by the current invention from the refuse distance.

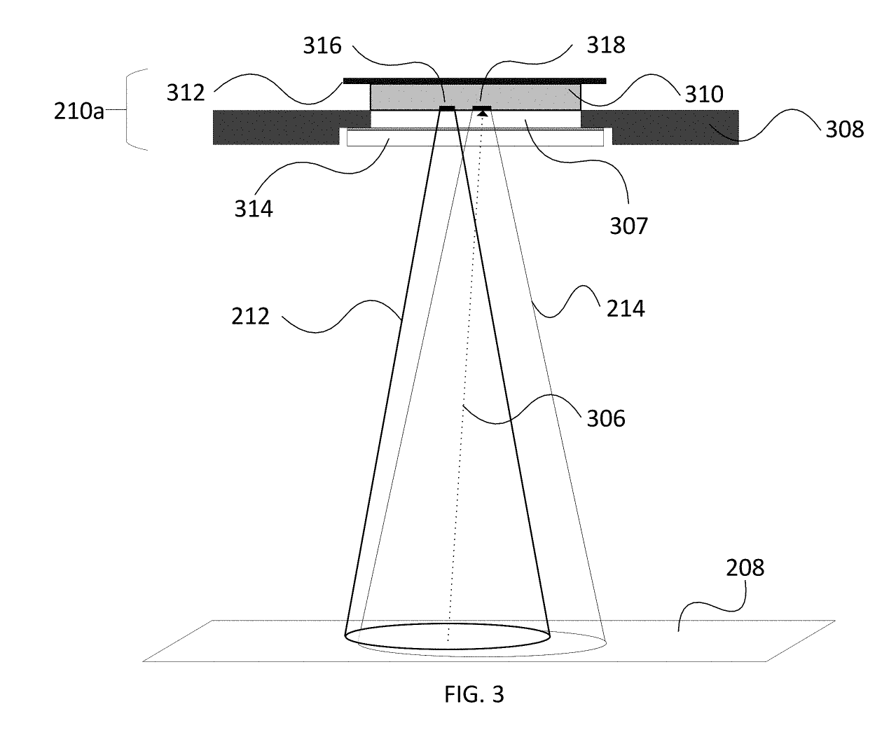

Referring now to FIG. 3, a simplified diagram of one embodiment of the invention is shown, in accordance with the invention. In general, a transmitter & sensor assembly 210a is positioned in a protective housing (not shown) underneath and attached to a refuse container lid (not shown), such that electromagnetic signal 212 may be first broadcast by transmitter 316 at a first time to a surface of refuse 208 (simplified), and then a portion of that signal 306 may be reflected back within sensor field of view 214 at a second time, and subsequently measured by sensor 318. In general, the difference between a first time and a second time may be used by the current invention to calculate the total flight time, and hence flight distance, of measured electromagnetic signal 212 from first transmitter 316 to a refuse surface, and then from refuse surface to sensor 318. Consequently, given a total distance, an estimated distance to a refuse surface may be calculated. When this estimated distance falls below a pre-determined amount, corresponding to a higher level of refuse, a notification may be generated and transmitted to a monitoring application.

In one embodiment, both transmitter 316 and sensor 318 are configured in an integrated module 310, commonly attached to a printed circuit board 312. An air gap 307 may separate integrated module 310 from a cover window 314. In one embodiment, air gap 307 is less than about 0.5 mm. In another embodiment, a protective cover window 314 may be configured with less than about a 2-degree tilt relative to transmitter 316.

In one embodiment, the transmitter is a laser. In another embodiment, the laser transmits in the infrared spectrum (between about 700 nanometers and about 1,000,000 nm). In another embodiment, the laser transmits between about 930 nm and about 950 nm. In another embodiment, the laser transmits at 940 nm. In another embodiment, cover window 314 is coated with an anti-fingerprint coating. In another embodiment, cover window 314 is coated with an anti-reflective coating. In another embodiment, cover window 314 is principally comprised of a polycarbonate material.

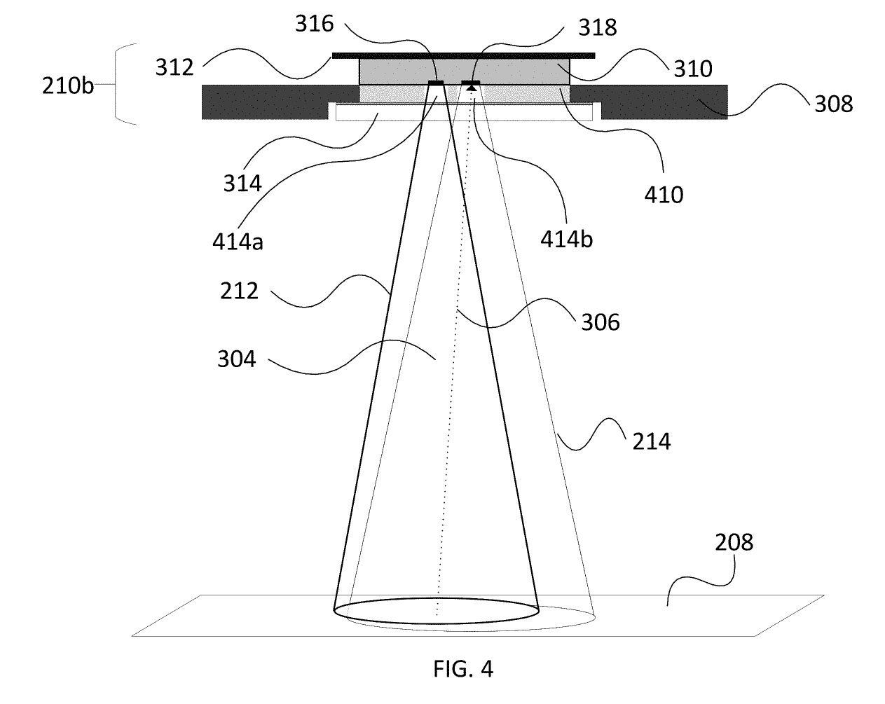

Referring now to FIG. 4, a simplified diagram of another embodiment of the invention is shown, in accordance with the invention. In general, a transmitter & sensor assembly 210b is positioned in a protective housing (not shown) underneath and attached to a refuse container lid (not shown), such that electromagnetic signal 212 is first broadcast by transmitter 316 at a first time to refuse 208 (simplified), and then a portion of that signal 306 may be reflected back and then measured by sensor 318 at a second time. Consequently, given a total distance, an estimated distance to a refuse surface may be calculated. When this estimated distance falls below a pre-determined amount, corresponding to a higher level of refuse, a notification may be generated and transmitted to a monitoring application.

In contrast to the embodiment as shown in FIG. 3, a gasket 410 further includes a transmission cavity 414a and a sensor cavity 414b in order to minimize signal cross-talk that may be generated by a cover window 314.

In general, cross-talk occurs when a signal transmitted on one circuit or channel of a transmission system creates an undesired effect in another circuit or channel. Substantially transparent, cover window 314, used to generally protect transmitter 316 and sensor 318, may also reflect a portion of the transmitted electromagnetic signal 212 from transmitter 316 back toward sensor 318, without first being reflected by refuse 208.

In one embodiment, both transmitter 316 and sensor 318 are configured in an integrated module 310, commonly attached to a printed circuit board 312.

In another embodiment, cover window 314 is configured with less than about a 2-degree tilt relative to transmitter 316.

In another embodiment, the transmitter is a laser. In another embodiment, the laser transmits in the infrared spectrum (between about 700 nanometers and 1,000,000 nm). In another embodiment, the laser transmits between 930 nm and 950 nm. In another embodiment, the laser transmits at 940 nm. In another embodiment, cover window 314 is coated with an anti-fingerprint coating. In another embodiment, cover window 314 is coated with an anti-reflective coating. In another embodiment, cover window 314 is principally comprised of a polycarbonate material.

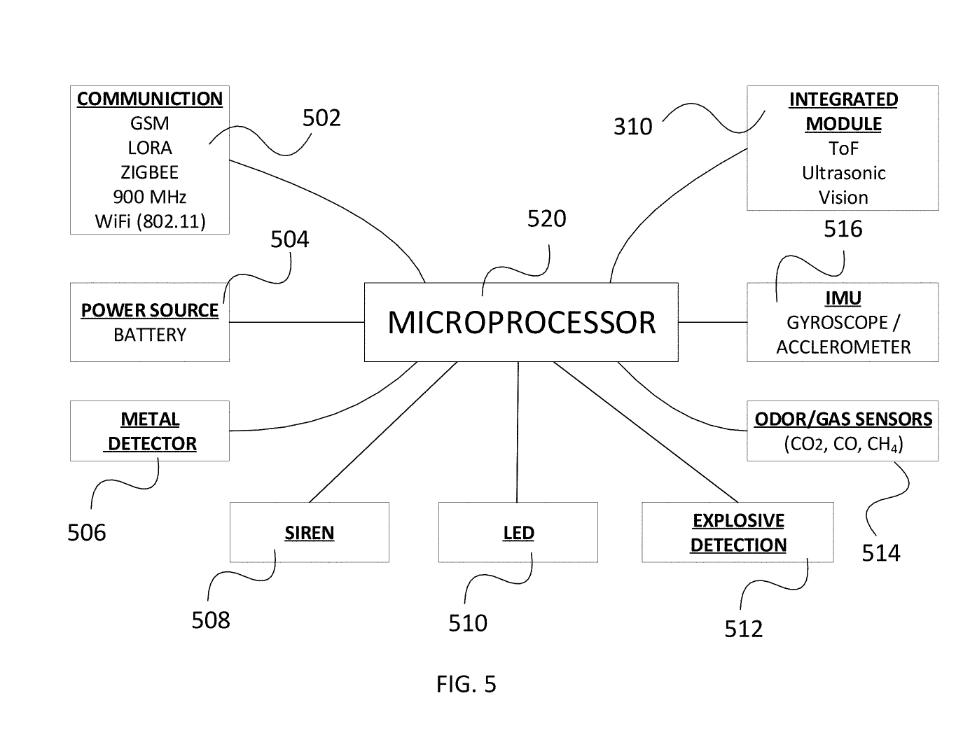

Referring now to FIG. 5, a simplified logical diagram of principal electronic components of a refuse monitoring apparatus is shown, in accordance with the invention.

In one embodiment, integrated microprocessor and radio module 520 is provided by ST Microelectronics. In another embodiment, the microprocess and radio functionality are each in a separate ASIC. In another embodiment, the microprocessor and radio functionality are in an integrated ASIC.

In one embodiment, a communications application specific integrated circuit (ASIC) 502 may be coupled to integrated microprocessor and radio module 520. In another configuration, communications ASIC 502 is configured with the LORA communications protocol.

In another embodiment, power source 504 is coupled to integrated microprocessor and radio module 520. In another embodiment, a metal detector ASIC may be coupled to microprocessor 520. For example, a metal detector ASIC may transmit an electromagnetic field into the refuse. Any metal objects within the electromagnetic field will become energized and retransmit an electromagnetic field of their own, which than be measured by the metal detector ASIC

In another embodiment, a siren ASIC 508 is coupled to integrated microprocessor and radio module 520. For example, if the refuse level inside refuse container (not shown) is within a prescribed distance of a sensor in integrated module 310, which is also coupled to microprocessor 520, siren ASIC 508 may initiate an audible sound indicating, for example, the current refuse state.

In another embodiment, LED 510 may also be coupled to integrated microprocessor and radio module 520. For example, LED 510 may display a solid color if refuse monitoring apparatus (not shown) does not report an error, blink in a prescribed pattern if a particular error occurs, or display no color if the refuse monitoring apparatus is turn off.

In another embodiment, an explosive detector 512 coupled to integrated microprocessor and radio module 520, is configured to monitor for chemical traces of explosives. Examples of types of explosive detector configurations include colorimetrics, ion mobility spectrometry, and thermos redox.

In another embodiment, odor/gas sensor 514, coupled to integrated microprocessor and radio module 520, is configured to measure molecules often generated by or in refuse, such as CO₂, CO, and CH₄.

In another embodiment, IMU (inertial measurement unit) sensor 516 configured with gyroscope and/or accelerometer functionality, is coupled to integrated microprocessor and radio module 520.

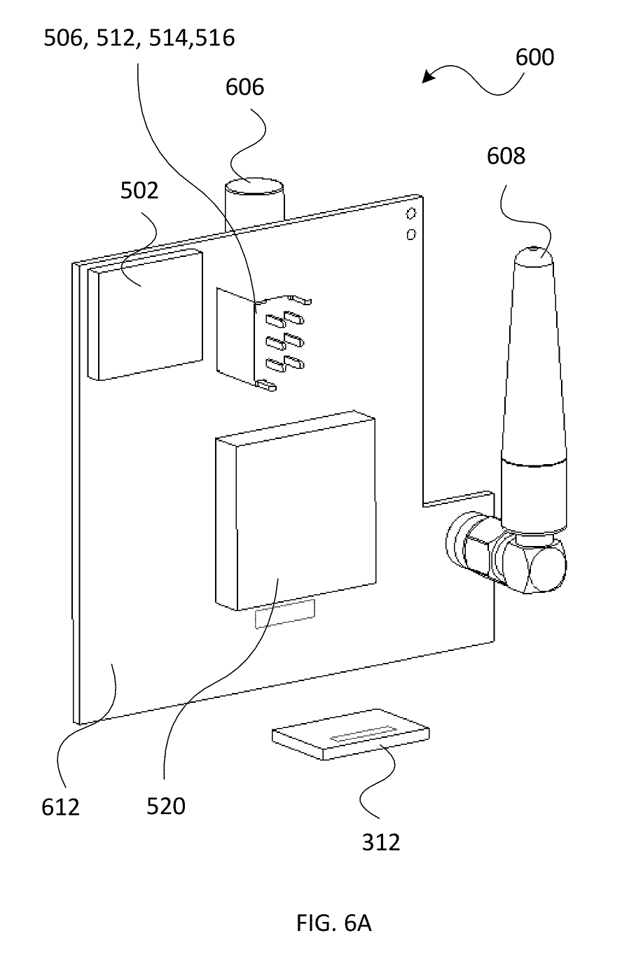

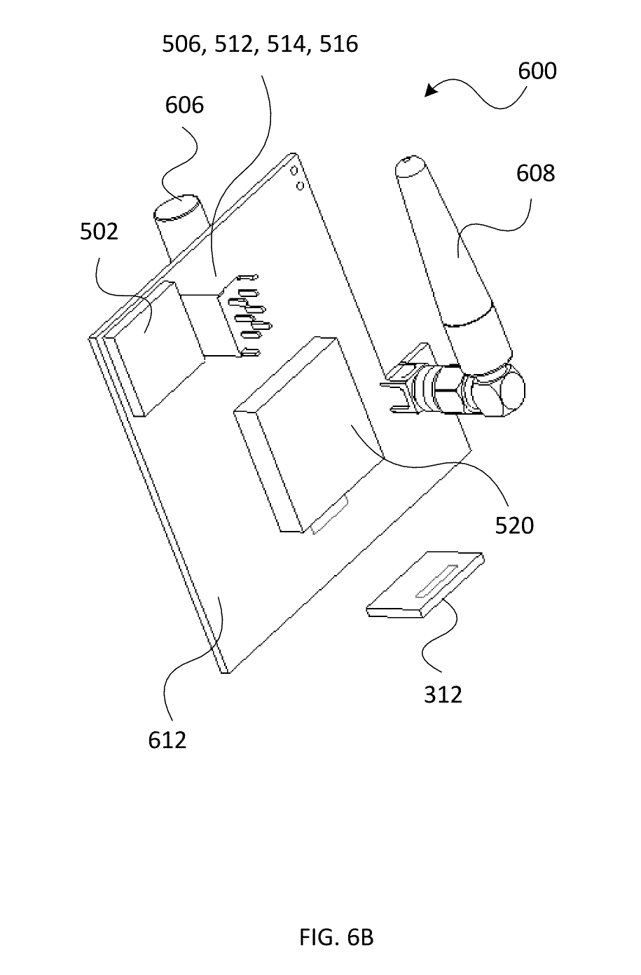

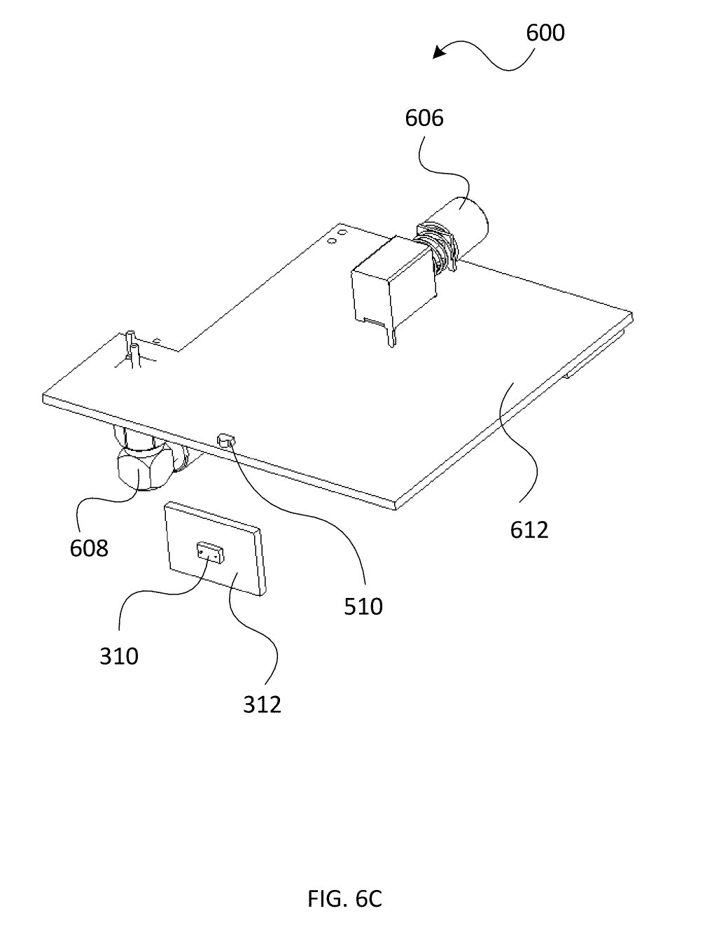

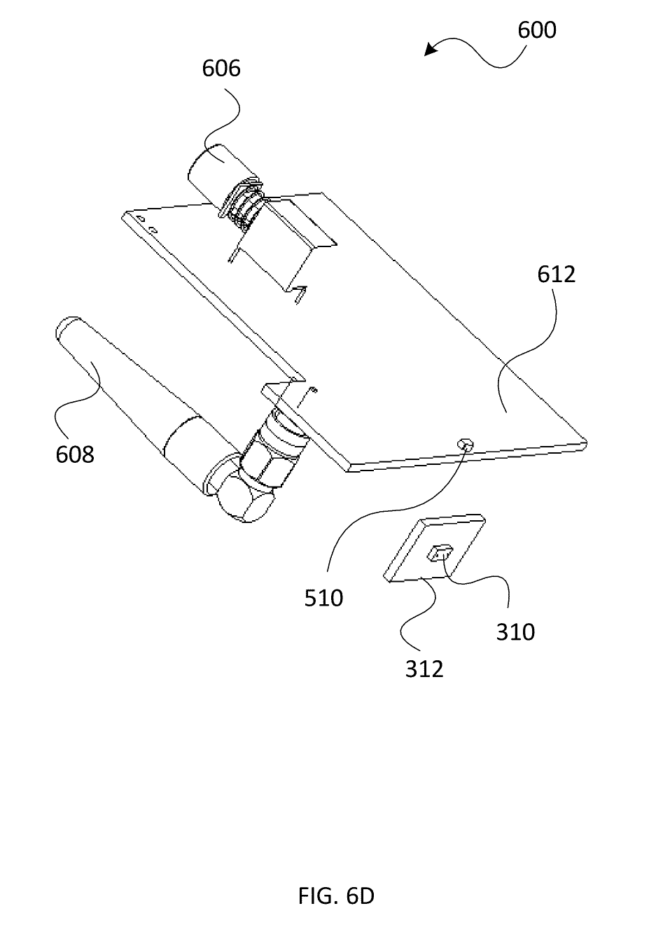

Referring now to FIGS. 6A-D, a simplified logical diagram of principal electronic components of a refuse monitoring apparatus, is shown, in accordance with the invention.

In general, a simplified diagram of printed circuit board assembly 600 is shown, comprised of main printed circuit board 612 and daughter printed circuit board 312. Daughter printed circuit board 312 further includes sensor 310, as previously described, and LED 510, and may be generally positioned perpendicular to main printed circuit board 612.

Main printed circuit board 612 includes to integrated microprocessor and radio module 520, communications ASIC 502, antenna 608, reset button 606, and optionally one or more of a metal detector ASIC 506, explosive detector 512, odor/gas sensor 514, and IMU (inertial measurement unit) sensor 516, as previously described.

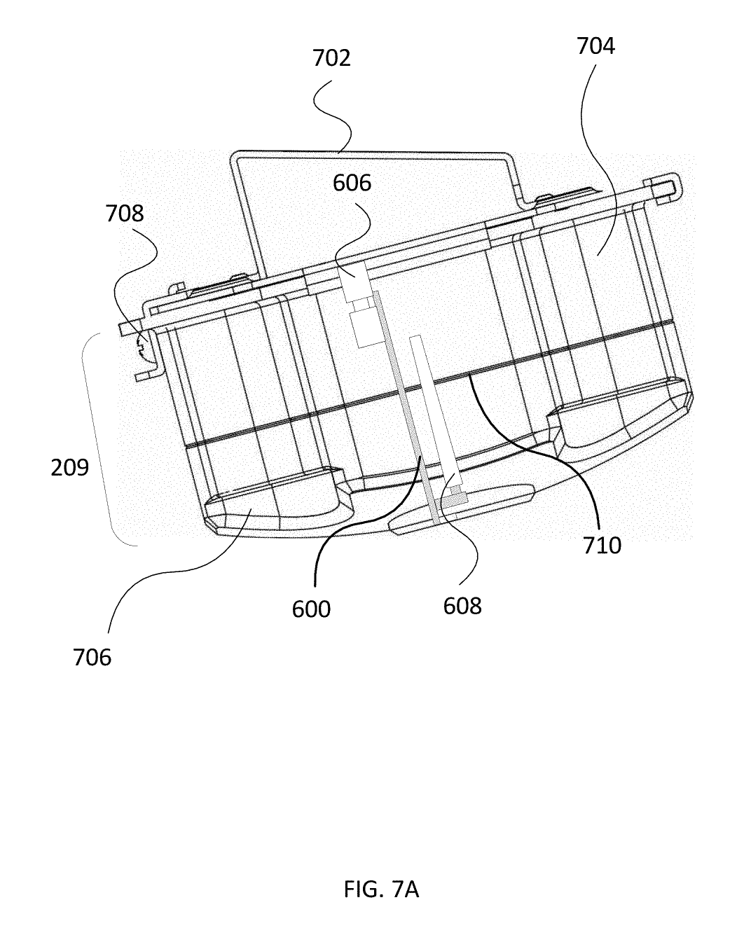

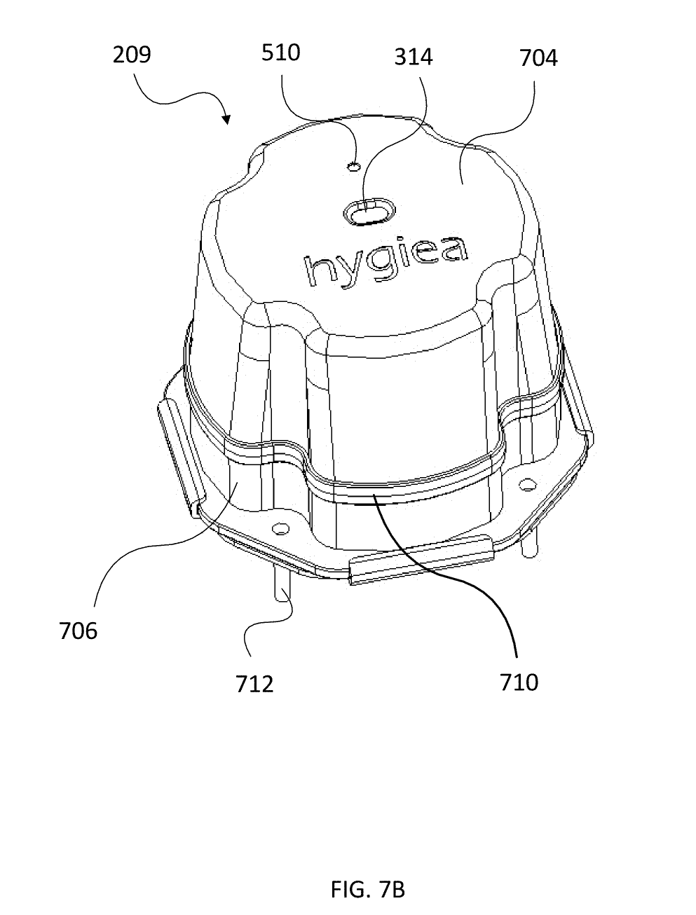

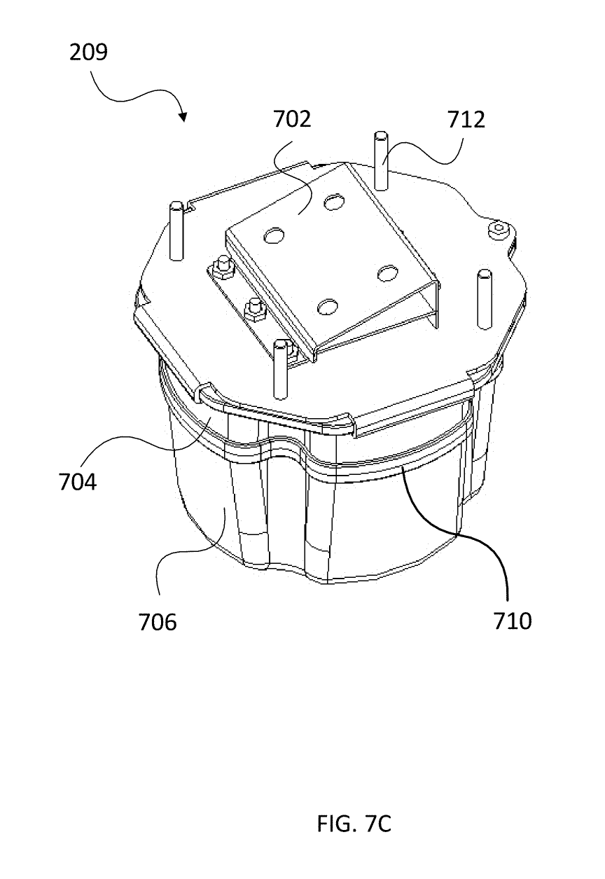

Referring now to FIGS. 7A-C, a housing unit and a mounting apparatus are shown, in accordance with the invention. In general, refuse monitoring apparatus 209 is generally configured as a container that protects the internal components from the local environment, as well as any mechanical shocks generated from opening and closing the refuse container lid (not shown).

The enclosure of refuse monitoring apparatus 209 may generally be configured in three parts: bottom section 706, top section 704, and gasket 710 configured sit between each section and maintain a substantially moisture resistant seal when assembled.

In one embodiment, bottom section 706 and top section 704 may be comprised of at least one of the following materials: acrylonitrile butadiene styrene, aikyd resins, amino resins, epoxy resins, ethylene vinyl acetate, phenol formaldehyde, polyacetal, polyamide, polycarbonate, polyesters, polyethylene, polymethyl methacrylate, polymethyl pentane, polyphenylene oxide, polyphenylene suiphide, polypropylene, polystyrene, polysulphone, polytetrafluoroethene, polyvinyl chloride, styrene acrylonitrile, urea formaldehyde. In addition, gasket 710 may be comprised of at least one of the following materials: polyurethane, neoprene, EPDM, vinyl nitrile, PVC, and polyethylene

Mounting unit 702 is configured to secure refuse monitoring apparatus 209 to a lid of refuse container [not shown], and position refuse monitoring apparatus 209 such that a level of refuse, or a chemical component within the refuse (not shown), may be monitored. In addition, refuse monitoring apparatus 209 may be further secured to mounting unit 702 via locking screw 708. In one embodiment, mounting unit 702 may be secured to a lid of refuse container [not shown], with a hook and loop fastener, such as Velco, or other type of adhesive material. In another embodiment, mounting unit 702 may be optionally secured to a lid of refuse container with a set of bolts 712 or other type of fastener.

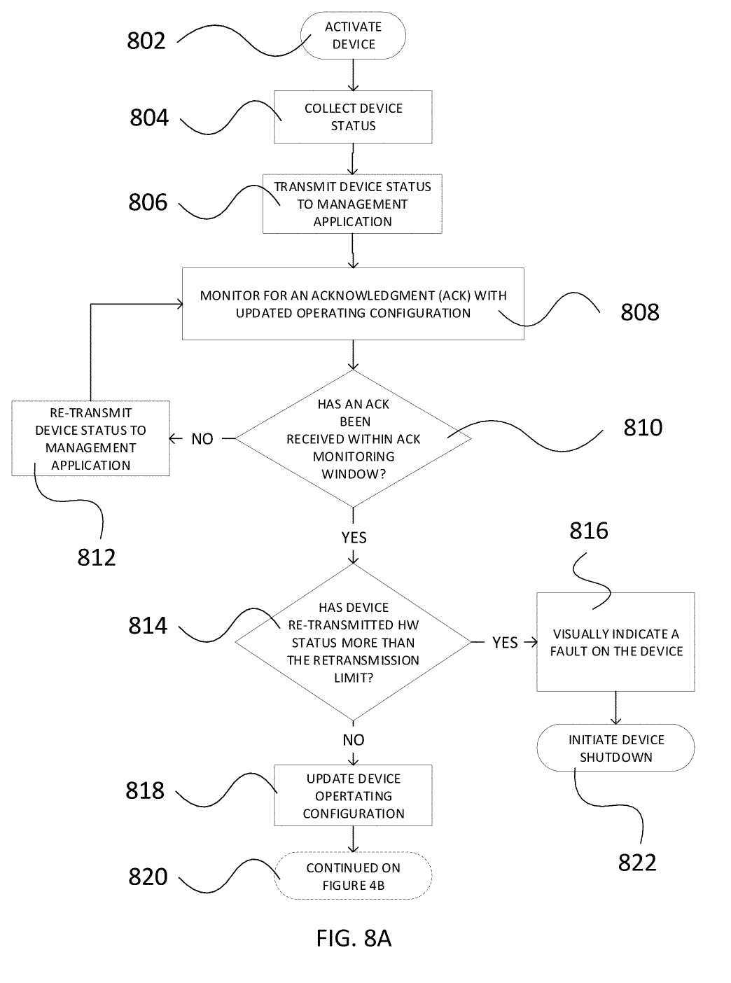

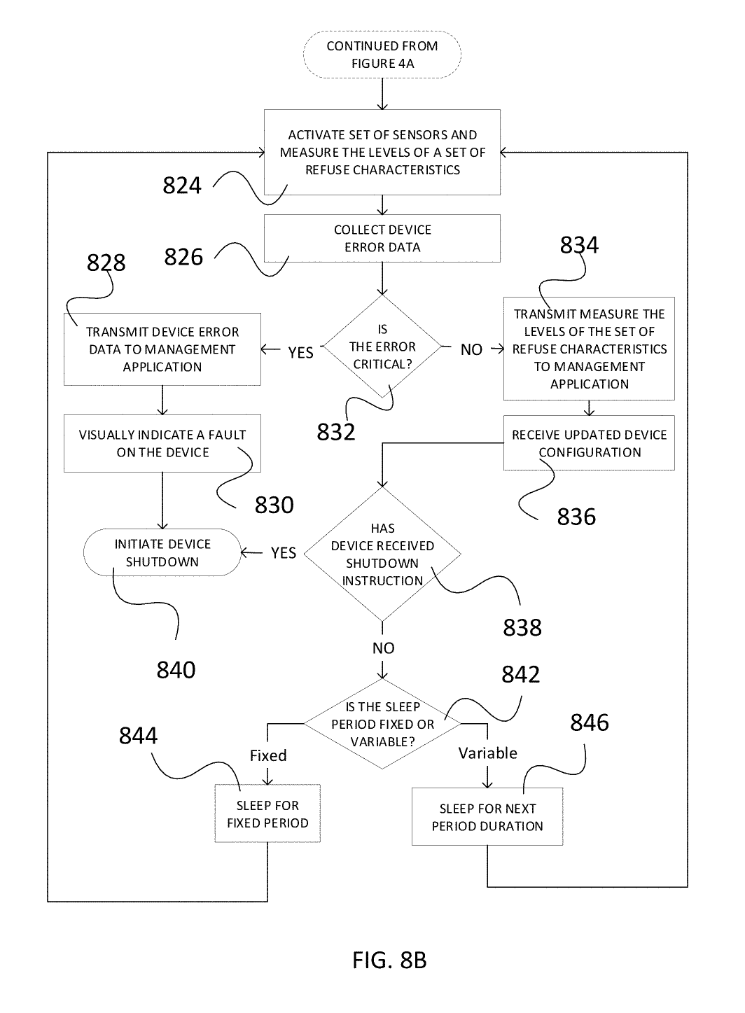

Referring now to FIGS. 8-A-B, a simplified process is shown of the invention, is shown, in with a set of sensors and transmitters are activated, configured, a signal is transmitted to a set of refuse, and a reflected signal is received from the transmitted, in accordance with the invention.

Initially, at step 802, a refuse monitoring device is activated.

Next, at step is 804, the device collects its status information. The device status is then transmitted to a management application at step 806. Examples of transmission mechanisms may include GSM, LORA, ZIGBEE, 900 MHz Wireless, and WIFI (i.e., 802.11). The device then monitors for an acknowledgement (ack) back from a management application at step 808

If an acknowledgement is not received within the ack monitoring window at 810, the device re-transmits device status to the management application at step 812. If the device has re-transmitted device status more than the allowed retransmission limit at 814, the device indicates a fault at 816, generally via an LED, as shown in FIG. 6D. The device then initiates a shutdown at step 822.

If the device has re-transmitted device status is not more than the allowed retransmission limit at 814, the device updates its operating configuration at 818.

The device then updates a set of sensors and begins measurement of the levels of a set of refuse characteristics at 824. Error data is also collected at 826 during the measurement period. If the device determines that a critical error has occurred at step 832, the device error data is then transmitted to the management application at 828. The device then visually indicates a fault on the device, generally via an LED. The device then initiates a shutdown at step 840.

In general, a fault is an event inhibits the refuse monitoring apparatus from operating within normal operating parameters. For example, a fault may occur if a battery source is about to be depleted, or the refuse monitoring apparatus has not reported the data to a server for a certain period of time and the device cannot determine that it is connected on the network. In an alternate example, a fault may occur if a physical shock is detected that is indicative of vandalism or potential sensor damage. At 832, if the device determines that a critical error has not occurred, the device then measure the levels of the set of refuse characteristics to management application at step 834.

At step 836, the device then receives an updated device configuration from the management.

The device then monitors for the receipt of a shutdown instruction at step 838. If the device has been configured for a fixed sleep period, the device sleeps for that fixed period at step 844, then re-activates the set of sensors at step 824. If the device has been configured for a variable sleep period, the device sleeps for that variable period at step 846, then re-activates the set of sensors at step 824.

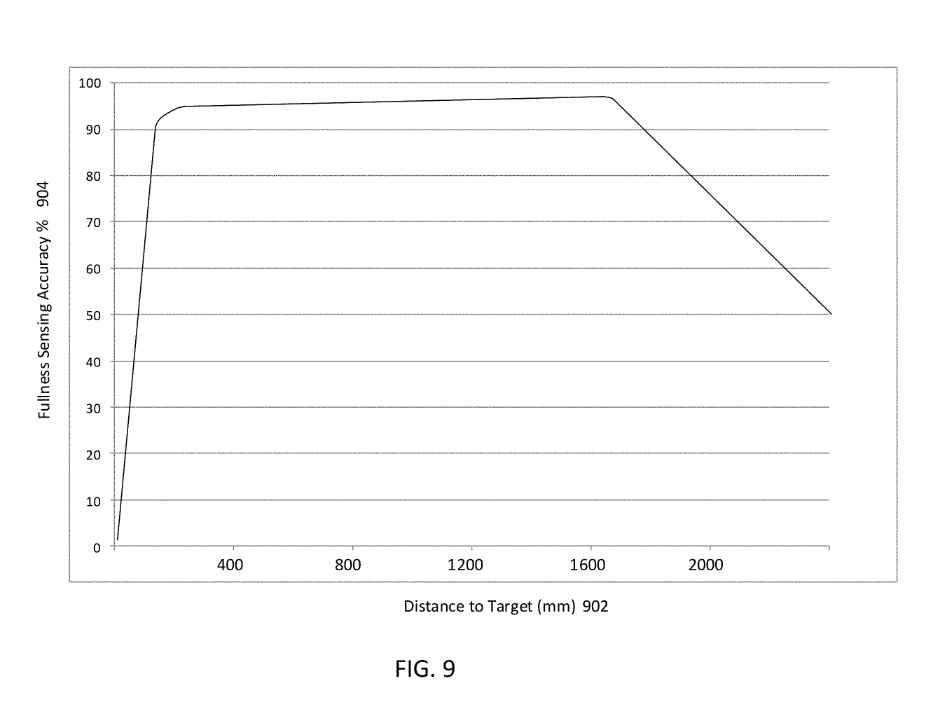

Referring now to FIG. 9, a simplified diagram showing fullness sensing accuracy vs. distance to target of the refuse monitoring apparatus in accordance of the invention. In general, the optimum distance from the sensor to a particular surface of refuse in the refuse container is between about 200 mm to about 2000 mm.

The invention has been described with reference to various specific and illustrative embodiments. However, it should be understood that many variations and modifications may be made while remaining within the spirit and scope of the invention.

Having disclosed exemplary embodiments and the best mode, modifications and variations may be made to the disclosed embodiments while remaining within the subject and spirit of the invention as defined by the following claims.

What is claimed is:

1. An apparatus for measuring the distance between a first sensor and a surface in a refuse container, the apparatus comprising:
a first transmitter, the first transmitter configured to transmit a first electromagnetic signal toward a set of surfaces at a first time;
a first receiver coupled to the first transmitter, the first receiver configured to receive a first reflected electromagnetic signal from the set of surfaces at a second time;
a distance calculating circuit coupled to the first receiver, the distance calculating circuit configured to calculate a first flight time period between the first time and the second time;
a time-distance conversion circuit coupled to the distance calculating circuit, the time-distance conversion circuit configured to convert the first flight time period to a first distance;
wherein a notification is generated if the first distance is less than a first threshold distance.

2. The apparatus of claim wherein the first transmitter a laser.

3. The apparatus is claim 2, wherein the laser transmits in a frequency between about 700 nanometers and about 1,000,000 nm,

4. The apparatus is claim 2, wherein the laser transmits in a frequency between about 930 nm and about 950 nm.

5. The apparatus is claim 2, wherein the laser transmits in a frequency about 940 nm.

6. The apparatus is claim 1 further including at least one of a gyroscope and accelerometer.

7. The apparatus is claim 1 further including at least one of a metal detector, an explosive detector, an odor/gas sensor, an inertial measurement unit sensor.

8. The apparatus is claim 1 further including a protective housing.

9. The apparatus is claim 1 further including an LED.

10. The apparatus of claim 1, where the first transmitter and the first receiver are configured on a first printed circuit board, and the distance calculating circuit is configured on a second printed circuit board.

11. The apparatus of claim 10, wherein the first printed circuit board is substantially perpendicular to the second printed circuit board.

12. The apparatus of claim 1 further including an antenna coupled to the distance calculating circuit.

13. The apparatus of claim 11, wherein the first printed circuit board and the second printed circuit board are positioned inside a secure housing unit.
